(19) United States
(12) Patent Application Publication
(10) Pub. No.: US 2024/0425183 A1
(43) Pub. Date: Dec. 26, 2024

(54) Wrap Over Crew Seat

(71) Applicant: Textron Aviation Inc., Wichita, KS (US)

(72) Inventors: Merril Binford Williams, Wichita, KS (US); Frank Joseph Rowe, Wichita, KS (US)

(21) Appl. No.: 18/662,133

(22) Filed: May 13, 2024

Related U.S. Application Data
(60) Provisional application No. 63/509,761, filed on Jun. 22, 2023.

(51) Int. Cl. B64D 11/06

(52) U.S. Cl. CPC B64D 11/0644; B64D 11/0689

(57) ABSTRACT

An aircraft seat includes a support extension with an arm support which extends over an aircraft side ledge. The support extension extends upwardly and outwardly from an aircraft seat bottom. The arm support supports and aligns a user's arm with a side stick controller positioned on the aircraft side ledge.

### CROSS-REFERENCE TO RELATED APPLICATIONS

This application claims the benefit of U.S. Provisional Patent Application No. 63/509,761, entitled Wrap Over Crew Seat and filed on Jun. 22, 2023, the entire contents of which are hereby incorporated by reference herein.

### BACKGROUND OF THE INVENTION

### 1. Field

The disclosed embodiments relate generally to the field of aviation seating. More specifically, the disclosed embodiments relate to a crew seat for aircraft cockpits.

### 2. Description of the Related Art

U.S. Pat. No. 8,276,845 to Orgerie et al. discloses an aircraft pilot seat including various adjustments that can be made to the pilot seat and armrest. U.S. Pat. No. 9,033,284 to Van Staagen discloses a pilot seat with adjustable features including an adjustable armrest. U.S. Pat. No. 10,683,100 to Bilbrey et al. discloses a pilot seat with integrated controls and an armrest that may be contoured with the pilot seat. U.S. Pat. Nos. 11,459,109and 11,498,685, both to Hoover et al., disclose a pilot seat with an automatic side-stick armrest.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages will be apparent from the following detailed description of the embodiments and the accompanying drawing figures.

In some embodiments, the techniques described herein relate to an aircraft crew seat including: a support extension extending upwards and outwards from a seat bottom; and an arm support extending horizontally outwards from a top portion of the support extension, wherein the arm support is configured to extend above a side ledge of an aircraft cockpit.

In some embodiments, the techniques described herein relate to a crew seat wherein the side ledge includes a side stick controller and the arm support is positioned over the side ledge for a crew member sitting in the aircraft seat to reach the side stick controller with a hand while resting their forearm on the arm support.

In some embodiments, the techniques described herein relate to a crew seat including: a first angle formed between the seat bottom and the support extension; a first gap configured between the support extension and side ledge; a second angle formed between the support extension and the arm support; and a second gap configured between the arm support and the side ledge.

In some embodiments, the techniques described herein relate to a crew seat wherein a tongue extends outwards from the arm support and is configured to be received into the top portion of the support extension to attach the arm support to the support extension.

In some embodiments, the techniques described herein relate to a crew seat wherein sliding the tongue out of the support extension adjusts the height of the arm support.

In some embodiments, the techniques described herein relate to a crew seat wherein a seat extension extends upwards and outwards from the seat bottom, the seat extension being disposed opposite from the support extension.

In some embodiments, the techniques described herein relate to a crew seat wherein the arm support is configured to support a user's arm while the user operates the side stick controller.

In some embodiments, the techniques described herein relate to a crew seat wherein a support frame inserts in a groove formed into a seat back for integrating the support frame with the seat back.

In some embodiments, the techniques described herein relate to a crew seat wherein the support frame is movable to adjust a distance between the support frame and an aircraft cockpit display.

In some embodiments, the techniques described herein relate to an aircraft seat including: a support extension configured to extend upwardly and outwardly from a seat bottom of the aircraft seat; an arm support configured to extend over a side ledge in an aircraft cockpit; wherein a height of the arm support is adjustable via a tongue that inserts into the support extension.

In some embodiments, the techniques described herein relate to an aircraft seat wherein the support extension extends at a first angle away from the seat bottom, the arm support extends at a second angle away from the support extension and aligns the arm support with a side stick controller configured on the side ledge.

In some embodiments, the techniques described herein relate to an aircraft seat wherein the tongue attaches the arm support to the support extension and the arm support is parallel to the side ledge.

In some embodiments, the techniques described herein relate to an aircraft seat wherein the support extension extends upwardly and outwardly from a left-hand side of the seat bottom such that the arm support extends over a left side ledge.

In some embodiments, the techniques described herein relate to an aircraft seat wherein the support extension extends upwardly and outwardly from a right-hand side of the seat bottom such that the arm support extends over a right side ledge.

In some embodiments, the techniques described herein relate to an aircraft seat wherein the seat bottom is mounted to a support frame configured to track in the inboard, outboard, fore, and aft directions such that a user may adjust a position of the arm support for reaching the side stick controller.

In some embodiments, the techniques described herein relate to an aircraft seat including: a seat bottom of the aircraft seat adapted with a support extension extending away from the seat bottom; an arm support configured to extend from the support extension at an angle, wherein the angle allows the arm support to be parallel to a top surface of a side ledge in an aircraft cockpit; and the support extension has a length allowing the arm support to extend over the top surface of the side ledge.

In some embodiments, the techniques described herein relate to an aircraft seat wherein the length of the support extension is adjustable to raise the arm support above the side ledge.

In some embodiments, the techniques described herein relate to an aircraft seat wherein the arm support supports an arm of a user seated in the aircraft seat and aligns the arm with a side stick controller.

In some embodiments, the techniques described herein relate to an aircraft seat wherein a seat extension extends from the seat bottom opposite the support extension.

In some embodiments, the techniques described herein relate to an aircraft seat being configured to track fore and aft, and inboard and outboard such that a user may adjust a position of the arm support for reaching the side stick controller.

### BRIEF DESCRIPTION OF SEVERAL VIEWS OF THE DRAWINGS

Illustrative embodiments are described in detail below with reference to the attached drawing figures, which are incorporated by reference herein and wherein:

FIG. 1A shows a front view of a wrap over crew seat, in an embodiment;

FIG. 1B shows a rear perspective view of the wrap over crew seat of FIG. 1A;

FIG. 1C shows a front perspective view of the wrap over crew seat of FIG. 1A;

FIG. 2 shows a side perspective view of the wrap over crew seat of FIG. 1A in an aircraft cockpit in an embodiment;

FIG. 3 shows a rear view of the wrap over crew seat of FIG. 1A in an aircraft cockpit in an embodiment;

FIG. 4 shows a side perspective view of the wrap over crew seat in an aircraft cockpit, in an embodiment; and

FIG. 5 shows a front perspective view of the wrap over crew seat in an embodiment.

The drawing figures do not limit the invention to the specific embodiments disclosed and described herein. The drawings are not necessarily to scale, emphasis instead being placed upon clearly illustrating the principles of the invention.

### DETAILED DESCRIPTION

The following detailed description references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the invention. The following detailed description is, therefore, not to be taken in a limiting sense. The scope of the invention is defined only by the appended claims, along with the full scope of equivalents to which such claims are entitled.

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments but is not necessarily included. Thus, the technology can include a variety of combinations and/or integrations of the embodiments described herein.

Embodiments disclosed herein provide an arrangement for aircraft cockpit seating which substantially improves crew member comfort. Current cockpit seating arrangements may be uncomfortable and may lead to crew fatigue. More specifically, fatigue may be created in current arrangements from a lack of support for a pilot's arm while accessing flight controls. Prior methods oftentimes include no armrest at all and rely solely on the side ledge itself to provide arm support for the aircraft control mechanism located on the side ledge (e.g., a side stick). In other instances, a crew seat may include a standard (e.g., straight) outboard armrest, but a standard armrest may be improperly aligned with the side ledge-mounted control mechanism. Disclosed embodiments include a system comprising a crew seat which incorporates an adjustable molded-in outboard armrest that extends directionally upwards from the crew seat and wraps up and over the cockpit side ledge to provide support for a pilot's arm while operating a side ledge mounted controller (e.g., a side stick).

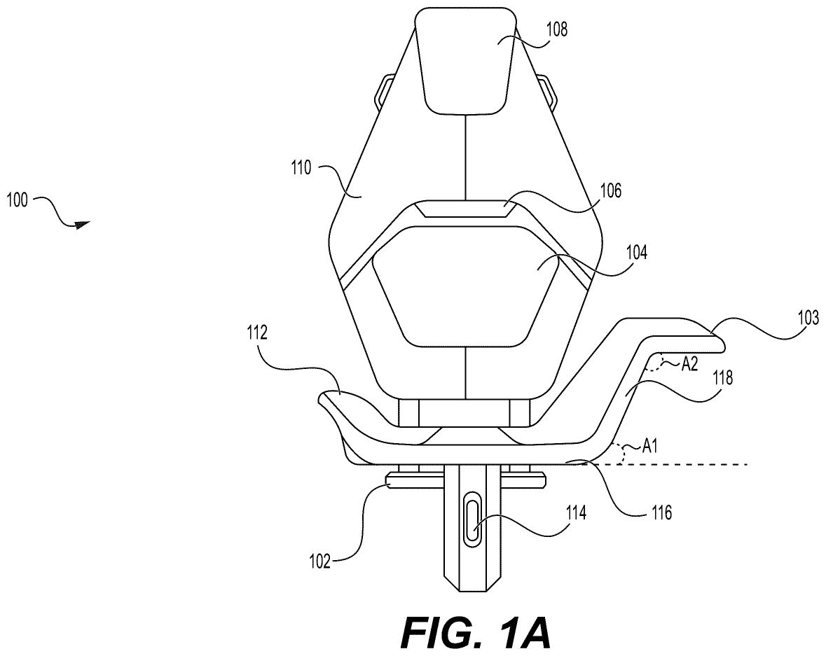

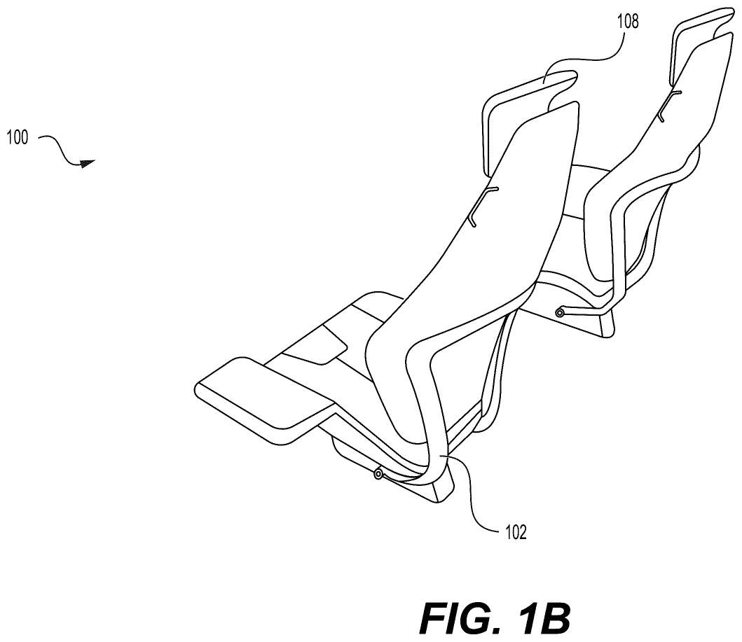

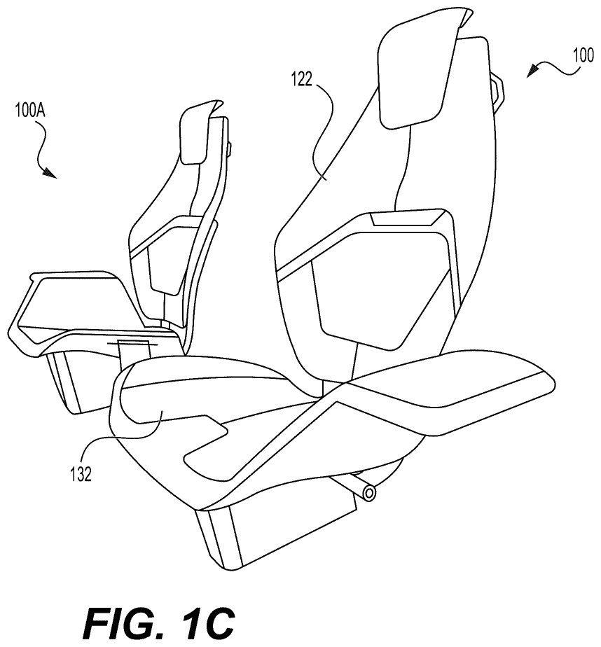

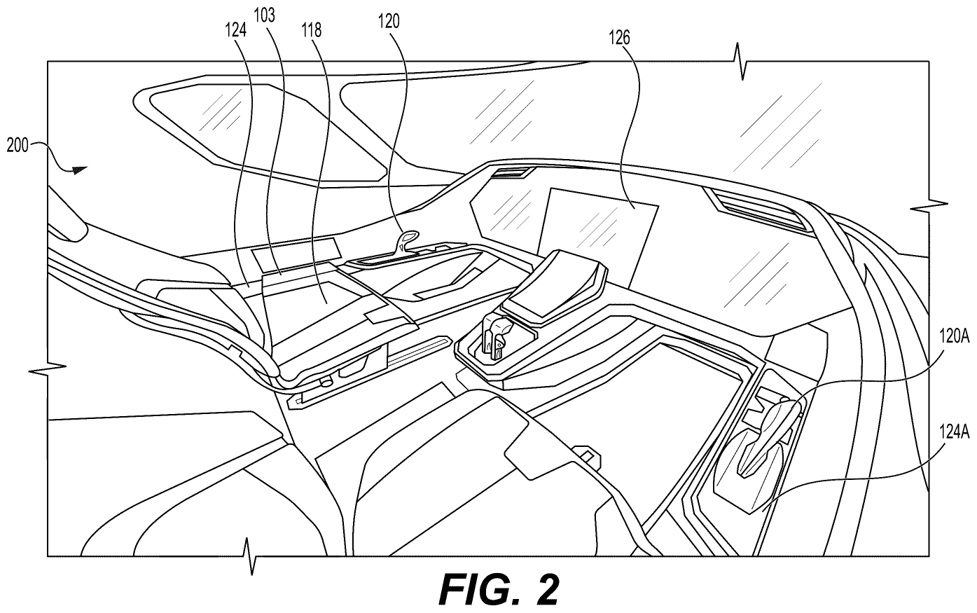

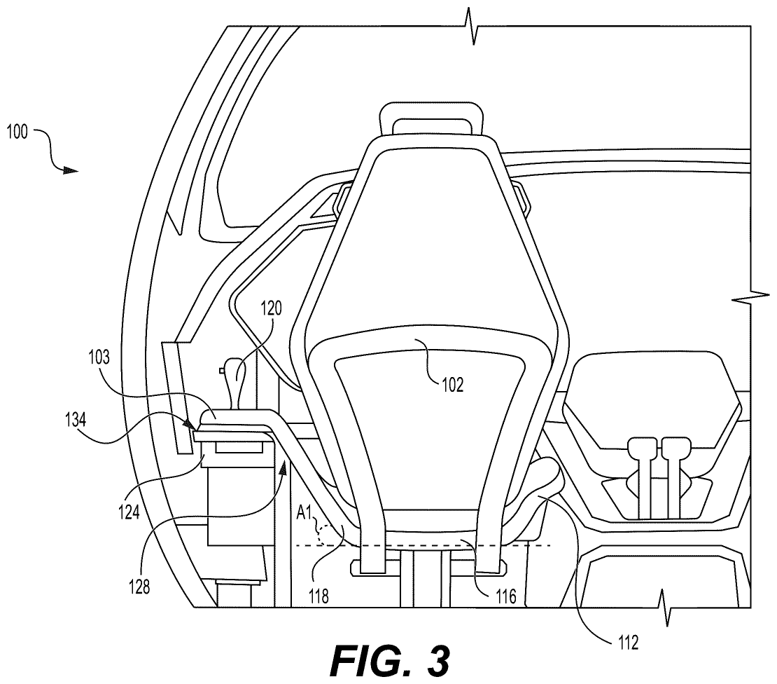

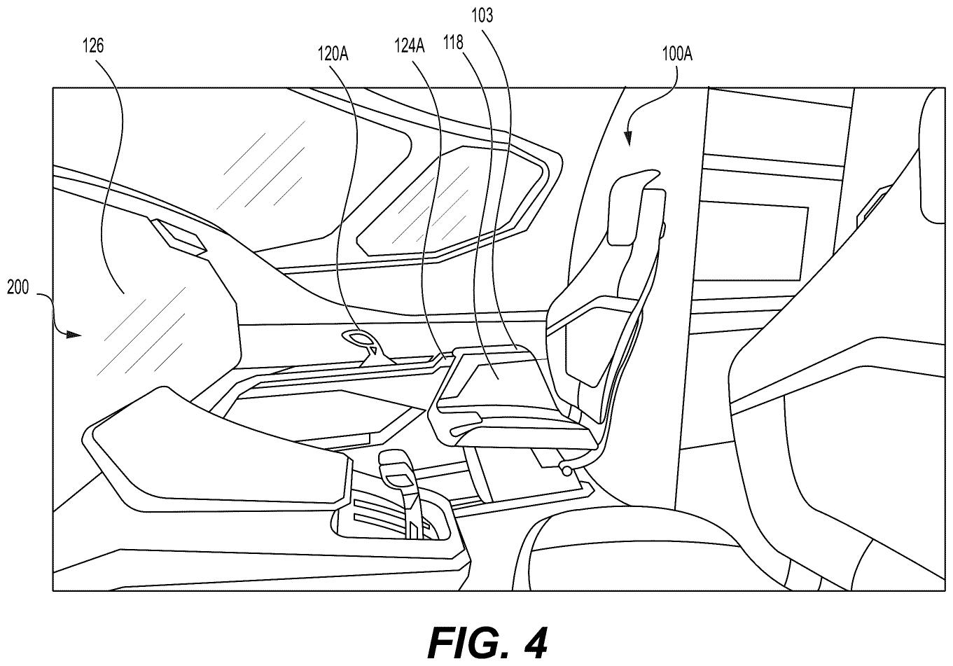

FIGS. 1A, 1B, and 1C provide views showing an embodiment of a wrap over crew seat 100 and are best viewed together. Referring to FIG. 1A, showing a front view, the wrap over crew seat 100 includes an arm support 103. The arm support 103 includes a support extension 118 that extends at an angle upwards and outwards from a seat bottom 116. In embodiments, the support extension 118 angles upwards and outwards from seat bottom 116 and is configured to extend the arm support 103 over a side ledge 124 of an aircraft cockpit (see FIGS. 2, 3, and 4). For example, the arm support 103 is adjustable so that it may be horizontally aligned with the side stick controller 120 configured on side ledge 124 to allow ideal lateral support for an arm/forearm of a crew member that is sitting in wrap over crew seat 100 and operating the side stick controller 120 with a hand. Arm support 103 extends substantially horizontally from a top portion of the support extension 118. The arm support 103 width may vary based on the width of the side ledge 124 in the cockpit of a particular aircraft. In embodiments, the arm support 103 may be between about 4 inches wide to about 7 inches wide to substantially cover the side ledge 124 (see FIGS. 3 and 4). In certain embodiments, the arm support 103 has a width of approximately 5.5 inches. The support extension 118 may have custom length and adjustability to allow for implementation into a cockpit on any type of aircraft with varying side ledge dimensions (e.g., width, length, and height). Opposite from the support extension 118, the seat bottom 116 includes a seat extension 112 which extends upwards and sideways away from the seat bottom 116. With reference to FIG. 1C, seat bottom 116 in embodiments includes upholstery 132 which may include two-tone contrasting cushions with contrast stitching.

Wrap over crew seat 100 includes a seat back 110. Seat back 110 may be an upward extension of the seat bottom 116 or alternatively, as shown in FIG. 1A, may be integrated into the support frame 102, or also possibly a combination of both such that the seat back 110 is substantially perpendicular to the seat bottom 116. In FIG. 1B, an alternate view of the support frame 102 is shown integrated with the seat back 110. Integration between the seat back 110 and the support frame 102 could be accomplished in a variety of different ways and should not be considered limiting within the scope of this application. One possible method to achieve integration is to form a groove into seat back 110 for the support frame 102 to insert into.

Shown in FIG. 1C, the seat back 110 includes seat back extensions 122 which flow outwardly away from the seat back 110. The seat back extensions 122 occur opposite one another on the seat back 110. The seat back extensions 122 may possibly serve as a means to increase the comfortability and/or increase the aesthetic appeal of crew seat 100. With reference to FIG. 1A, seat back 110 includes a lumbar support element 104. The lumbar support element 104 may include curvature which protrudes outwards from seat back 110 to support a person's lower back region while seated in the wrap over crew seat 100. The lumbar support element 104 may be fabricated with a mesh or other breathable material to enhance ventilation. In some embodiments, position of the lumbar support element 104 may be adjusted by enabling a user to adjust the height of the lumbar support element 104 to achieve a desired amount of support for improved comfort. In embodiments, directly above the lumbar support element 104, the seat back 110 includes a possible location for a marking 106 such as an emblem. The upper portion of the seat back 110 includes a head support 108. The head support 108 protrudes axially outwards from the seat back 110 and may serve as a means of supporting a person's head while seated in the wrap over crew seat 100. A user may also have the capability to adjust the head support 108 to achieve a desired position. An alternative view of the axial extension of the head support 108 is shown in FIG. 1B. Additionally, crew seat 100 may include a lighting effect 114 below the seat bottom 116. The lighting effect 114 may include illuminated markings comprising one or more light-emitting diodes (LEDs), for example. The wrap over crew seat 100 may be fabricated entirely from one material or numerous different materials. The fabrication of the supports, elements, and extensions of the wrap over crew seat 100 should not be considered limiting within the scope of this application.

FIG. 1C shows a second wrap over crew seat 100A which has a mirror-image shape of the wrap over crew seat 100. The second wrap over crew seat 100A is configured for use on the opposite side of the cockpit (e.g., by the copilot). The second wrap over crew seat 100A includes substantially similar elements to wrap over crew seat 100. Items enumerated with like numerals are the same or similar and their description may not be repeated accordingly. For example, second crew seat 100A also includes arm support 103; however, second crew seat 100A extends from the right-hand side of seat bottom 116 instead of the left-hand side, thereby providing support for a copilot's right arm while accessing a side stick controller 120A on a side ledge 124A (see FIGS. 2 and 4) with their right arm.

FIG. 2 shows a side perspective view of the wrap over crew seat 100 in a cockpit environment. In FIG. 2, the side ledges 124 and 124A of the aircraft are shown. Side ledge 124 and side ledge 124A are disposed on the leftmost and rightmost sides of the aircraft cockpit 200 respectively. The side ledges 124 and 124A protrude out from the cockpit walls of the aircraft on either side of the aircraft cockpit 200. Side ledges 124 and 124A both extend from the cockpit control display 126 and continue toward the rear of the aircraft cockpit 200. Side stick controllers 120 and 120A are positioned on the side ledges 124 and 124A between the arm support 103 and the cockpit control display 126.

FIG. 3 shows a rear view of wrap over crew seat 100 in a cockpit environment. In this view, the support frame 102 is integrated with the seat back 110. The support frame 102 is shown in embodiments to integrate with the seat back 110 with a shape that flairs upwards and outwards substantially following a curvature of the seat back 110 shape. With reference to FIG. 1A and FIG. 3, the support extension 118 is shown to flair outwards and upwards from the seat bottom 116 at a first angle A1 measured between the seat bottom 116 and support extension 118 (e.g., a zero degree angle would indicate that the support extension 118 extends horizontally outwards from the seat bottom 116, and a ninety degree angle would indicate that the support extension 118 extends vertically upwards from the seat bottom 116). The first angle A1 and length of the support extension 118 is such that a first gap 128 is created between the side ledge 124 and the support extension 118. The first angle A1 and length of the support extension 118 allow for the arm support 103, positioned near the top of the support extension 118, to extend over a top surface of side ledge 124. The length and first angle of the support extension 118 may vary depending on the particular aircraft cockpit arrangement. For instance, in some embodiments, the support extension 118 has a first angle A1 shown to be approximately between sixty degrees and eighty-five degrees. In certain embodiments, the first angle A1 is between seventy and eighty degrees.

FIG. 4 provides an alternate view of the second wrap over crew seat 100A including the side ledge 124A, support extension 118, and the arm support 103. FIG. 4 shows the support extension 118 extending upwards to allow the arm support 103 to extend substantially over the side ledge 124A.

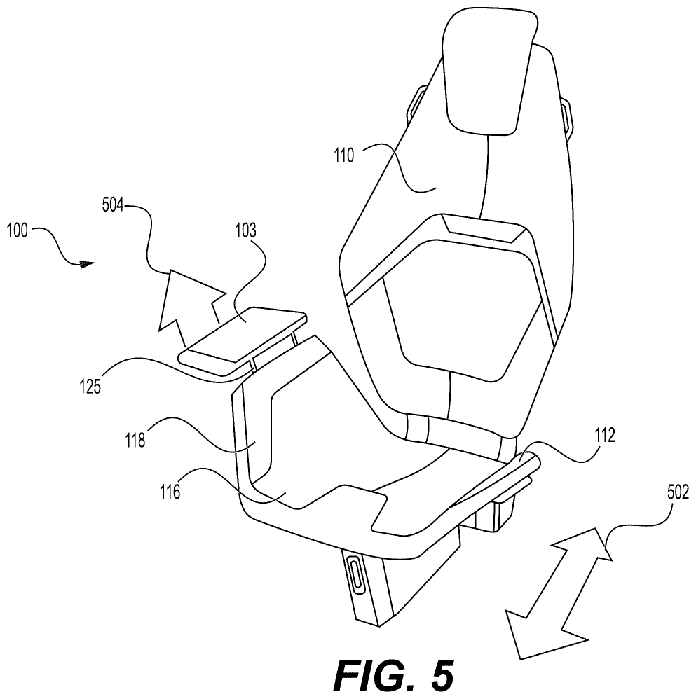

In embodiments, with reference to FIG. 5, a tongue 125 attaches arm support 103 to the upper portion of support extension 118 to provide an adjustable support extension. The tongue 125 is configured to be received and slide into and out of support extension 118 which allows for the height of the arm support 103 to be adjusted relative to support extension 118 and seat bottom 116. For instance, when the arm support 103 is elevated, arm support 103 is pulled in a direction aligned with support extension 118 such that tongue 125 extends from support extension 118. In some embodiments, the amount of retraction or extension of tongue 125 may be controlled using a remote or touch sensitive control panel which moves arm support 103 up or down. Tongue 125 is substantially able to support arm support 103 in a horizontal position parallel to side ledge 124. In some embodiments, tongue 125 may include slits, notches, or other elements such that its position may be locked relative to support extension 118 for arm support 103 to maintain a desired height.

With reference to FIG. 1A, the arm support 103 in embodiments is shown to extend horizontally outwards and away from the support extension 118 at a second angle A2 measured between the support extension 118 and arm support 103. The second angle A2 is such that the underside surface of arm support 103 may be substantially parallel with the upper surface of side ledge 124. FIG. 3 shows a second gap 134 between the side ledge 124 and the arm support 103. The distance of second gap 134 may be increased or decreased by adjusting the height of arm support 103 via the adjustable support extension of the FIG. 5 embodiment.

Crew seat 100 may also include standard seat controls for seat adjustment. Control for seat adjustment could be accomplished in a variety of different ways with one possible way being a touch sensitive control panel (not shown). A touch sensitive control panel may be located anywhere on the wrap over crew seat 100, such as on the arm support 103, or on the side ledge 124, for example. As discussed above, the crew seat 100 may also be on a track system to accommodate various sizes of crew members while also including possible independent height adjustment of the arm support 103 to be ideally positioned with the side stick controller 120. This may be done by adjusting the length of tongue 125 that extends out of the top portion of the support extension 118 (FIG. 5).

Ideal lateral support may be achieved for pilots of different sizes using fore-aft adjustment of the wrap over crew seat 100. Fore-aft seat adjustment may be accomplished using, for example, a track system configured to allow the wrap over crew seat 100 to move longitudinally (i.e., fore and aft) and having capability to lock at a desired position. Additionally, lateral seat adjustment may be provided for inboard/outboard translation, which may be used to align arm support 103 and a user's arm/forearm, with the side stick controller 120, in embodiments.

Shown in FIG. 5 is the wrap over crew seat 100 with fore-aft seat adjustment indicated with a multidirectional arrow 502. The multidirectional arrow 502 demonstrates the ability of the user to adjust the wrap over crew seat 100 in a forward or aft direction to a desired position. Also shown in FIG. 5 is an arrow 504 indicating the independent adjustment of the arm support 103. The arrow 504 indicates the direction in which the support extension 118 may be raised so that the arm support 103 may be set to a desired position. Due to the angle A1 (FIGS. 1A and 3) of support extension 118, raising arm support 103 increases its height while simultaneously moving arm support 103 outboard. The wrap over crew seat 100 may be adjusted to move forward (closer) or backward (away) from the cockpit control display 126. Adjusting the wrap over crew seat 100 closer to the cockpit control display 126 allows the arm support 103 to shift a closer distance to the side stick controller 120. Adjusting the wrap over crew seat 100 away from the cockpit control display 126 allows the arm support 103 to shift a further distance away from the side stick controller 120. The crew seat 100 may also be moved laterally inboard and outboard to adjust a lateral position of the arm support 103 over the side ledge 124, 124A for accommodating users of different sizes and arm lengths. At a distance away from the side stick controller 120, the arm support 103 may be adjusted by increasing or decreasing its height above the support extension 118 for a user to obtain a desired arm position (see FIG. 5).

Different arrangements of the wrapped over crew seat 100 are possible within alternative environments utilizing a control mechanism, such as in an automobile or commercial vehicle.

Many different arrangements of the various components depicted, as well as components not shown, are possible without departing from the spirit and scope of what is claimed herein. Embodiments have been described with the intent to be illustrative rather than restrictive. Alternative embodiments will become apparent to those skilled in the art that do not depart from what is disclosed. A skilled artisan may develop alternative means of implementing the aforementioned improvements without departing from what is claimed.

It will be understood that certain features and subcombinations are of utility and may be employed without reference to other features and subcombinations and are contemplated within the scope of the claims. Not all steps listed in the various figures need be carried out in the specific order described.

What is claimed is:

1. An aircraft crew seat comprising:
a support extension extending upwards and outwards from a seat bottom; and
an arm support extending horizontally outwards from a top portion of the support extension,
wherein the arm support is configured to extend above a side ledge of an aircraft cockpit.

2. The crew seat of claim 1 wherein the side ledge comprises a side stick controller and the arm support is positioned over the side ledge for a crew member sitting in the aircraft seat to reach the side stick controller with a hand while resting their forearm on the arm support.

3. The crew seat of claim 1 comprising:
a first angle formed between the seat bottom and the support extension;
a first gap configured between the support extension and side ledge;
a second angle formed between the support extension and the arm support; and
a second gap configured between the arm support and the side ledge.

4. The crew seat of claim 1 wherein a tongue extends outwards from the arm support and is configured to be received into the top portion of the support extension to attach the arm support to the support extension.

5. The crew seat of claim 4 wherein sliding the tongue out of the support extension adjusts the height of the arm support.

6. The crew seat of claim 1 wherein a seat extension extends upwards and outwards from the seat bottom, the seat extension being disposed opposite from the support extension.

7. The crew seat of claim 2 wherein the arm support is configured to support a user's arm while the user operates the side stick controller.

8. The crew seat of claim 1 wherein a support frame inserts in a groove formed into a seat back for integrating the support frame with the seat back.

9. The crew seat of claim 8 wherein the support frame is movable to adjust a distance between the support frame and an aircraft cockpit display.

10. An aircraft seat comprising:
a support extension configured to extend upwardly and outwardly from a seat bottom of the aircraft seat;
an arm support configured to extend over a side ledge in an aircraft cockpit;
wherein a height of the arm support is adjustable via a tongue that inserts into the support extension.

11. The aircraft seat of claim 10 wherein the support extension extends at a first angle away from the seat bottom, the arm support extends at a second angle away from the support extension and aligns the arm support with a side stick controller configured on the side ledge.

12. The aircraft seat of claim 10 wherein the tongue attaches the arm support to the support extension and the arm support is parallel to the side ledge.

13. The aircraft seat of claim 10 wherein the support extension extends upwardly and outwardly from a left-hand side of the seat bottom such that the arm support extends over a left side ledge.

14. The aircraft seat of claim 10 wherein the support extension extends upwardly and outwardly from a right-hand side of the seat bottom such that the arm support extends over a right side ledge.

15. The aircraft seat of claim 11 wherein the seat bottom is mounted to a support frame configured to track in the inboard, outboard, fore, and aft directions such that a user may adjust a position of the arm support for reaching the side stick controller.

16. An aircraft seat comprising:
a seat bottom of the aircraft seat adapted with a support extension extending away from the seat bottom;
an arm support configured to extend from the support extension at an angle,
wherein the angle allows the arm support to be parallel to a top surface of a side ledge in an aircraft cockpit; and
the support extension has a length allowing the arm support to extend over the top surface of the side ledge.

17. The aircraft seat of claim 16 wherein the length of the support extension is adjustable to raise the arm support above the side ledge.

18. The aircraft seat of claim 16 wherein the arm support supports an arm of a user seated in the aircraft seat and aligns the arm with a side stick controller.

19. The aircraft seat of claim 16 wherein a seat extension extends from the seat bottom opposite the support extension.

20. The aircraft seat of claim 18 being configured to track fore and aft, and inboard and outboard such that a user may adjust a position of the arm support for reaching the side stick controller.
